(19) United States
(12) Patent Application Publication
(10) Pub. No.: US 2026/0054500 A1
(43) Pub. Date: Feb. 26, 2026

(54) Method and Device for Detecting an Air Inclusion in a Print Head

(71) Applicant: Canon Production Printing Holding B.V., Venlo (NL)

(72) Inventors: Florian Hitzlsperger, Poing (DE); Ulrich Stöckle, München (DE); Christoph Rummelsberger, Ismaning (DE)

(21) Appl. No.: 19/306,144

(22) Filed: Aug. 21, 2025

(30) Foreign Application Priority Data
Aug. 22, 2024 (DE) 10 2024 123 991.3

(51) Int. Cl. B41J 2/19; B41J 2/175

(52) U.S. Cl. CPC B41J 2/19; B41J 2/17596

(57) ABSTRACT

A device is described for detecting a print head group of a print bar of an inkjet printing device having an air inclusion. The device determines resistance information with respect to the internal resistance of one or more ink supply channels of a print head group of the print bar and, based on the resistance information, determines whether or not the print head group has an air inclusion.

### CROSS-REFERENCE TO RELATED APPLICATION

This application claims priority to German Patent Application No. 10 2024 123 991.3 filed Aug. 22, 2024, the disclosure of which is hereby incorporated by reference in its entirety.

### BACKGROUND OF THE INVENTION

### Field of the Invention

The invention relates to a method and a corresponding device that enable an air inclusion in a print head of a print bar of an inkjet printing device to be detected efficiently and reliably.

### Description of Related Art

An inkjet printing device for printing to a recording medium can comprise a print bar having one or more print heads with respectively one or more nozzles. The nozzles are respectively configured to eject ink droplets in order to print dots of a print image onto the recording medium. The individual print heads of a print bar are supplied with ink by an ink supply system.

During the operation of a print head and/or during a servicing procedure of a print head, air can be drawn into the print head via one or more nozzles, in particular into the ink chambers of the one or more nozzles of the print head. The air inclusion in a print head can lead to a negative effect on the print quality of the printing device.

### SUMMARY OF THE INVENTION

The present document deals with the technical object of detecting an air inclusion in a print head early and reliably in order to efficiently increase the print quality of a printing device. The object is respectively achieved by the features described herein.

According to one aspect, a device is described for detecting a print head group of a print bar of an inkjet printing device, said print head group having an air inclusion. The device is configured to determine resistance information with respect to the internal resistance of one or more ink supply channels of a print head group of the print bar and, based on the resistance information, to determine whether or not the print head group has an air inclusion.

According to one aspect, a method is described for detecting a print head group of a print bar of an inkjet printing device that has an air inclusion. The method comprises the determination of resistance information with respect to the internal resistance of one or more ink supply channels of a print head group of the print bar. Furthermore, the method comprises the determination, based on the resistance information, of whether or not the print head group has an air inclusion.

### BRIEF DESCRIPTION OF THE DRAWINGS

In the following, exemplary embodiments of the invention are described in detail using the schematic drawings. Shown therein are:

FIG. 1 a block diagram of an example of an inkjet printing device;

FIG. 2 an example of an ink supply system for one or more print heads of a print bar of an inkjet printing device;

FIG. 3 examples of measured pressure values for different print heads of a print bar; and

FIG. 4 a workflow diagram of an example of a method for detecting a print head negatively affected by air inclusion.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

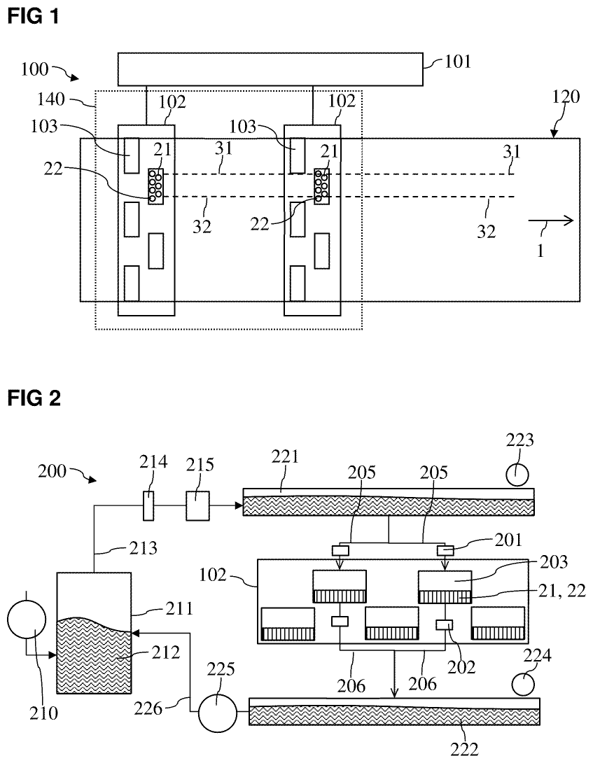

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 typically comprises at least one fixing or drying unit that is not shown in FIG. 1 and that is configured to fix a print image printed onto the recording medium 120.

A print bar 102 can comprise one or more print heads 103 that are possibly arranged side by side in a plurality of rows in order to print the dots of different columns 31, 32 of a print image onto the recording medium 120. In the example presented in FIG. 1, a print bar 102 comprises five print heads 103, wherein each print head 103 prints the dots of a group of columns 31, 32 of a print image onto the recording medium 120. The number of print heads 103 of a print bar 102 can, for example, be 5, 10, or more.

In the embodiment depicted in FIG. 1, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control device 101, for example a driving hardware and/or a controller, that is configured to drive the actuators of the individual nozzles 21, 22 of the individual print heads 103 of the print group 140 in order to apply the print image onto the recording medium 120 depending on print data. In an exemplary embodiment, the control device 101 includes processing circuitry or at least one processor that is configured to perform one or more functions and/or operations of the control device 101, including activating the actuators of the individual nozzles 21, 22 of the individual print heads 103 of the print group 140 to apply the print image onto the recording medium 120 based on print data, processing print and/or other data, control one or more modes of the printing device 100 and/or controlling one or more operations of the printing device 100. In an exemplary embodiment, the control device 101 includes one or more interfaces (e.g. a wired and/or wireless input and/or output interface, transceiver, or the like) that are configured to receive or output data or information. For example, the control device 101 may receive signals generated by one or more components of the printing device 100 (e.g. from a user interface of the printing device 100) and/or output control signals to one or more components of the printing device 100. In an exemplary embodiment, the control device 101 includes a memory configured to store data/information, and/or store executable code that is executable by the processing circuitry to cause the processing circuitry or at least one processor to perform the operation(s) of the control device 101.

The print group 140 of the printing device 100 thus comprises at least one print bar 102 having K nozzles 21, 22 that can be arranged in one or more print heads 103 and that can be driven with a defined line timing in order to print a respective line with K pixels or K columns 31, 32 of a print image into the recording medium 120, for example with K>1000, said line running transverse to the transport direction 1 of said recording medium 120. In the shown example, the nozzles 21, 22 are installed immobile or fixed in the printing device 100, and the recording medium 120 is directed past the stationary nozzles 21, 22 with a defined transport velocity.

FIG. 2 shows an example of an ink supply system 200 that is designed to supply one or more print heads 103 of a print bar 102 with ink 212. One or more print heads 103 can thereby be assembled into a print head group 203, wherein the one or more print heads 103 of a print head group 203 are supplied with ink 212 via a common ink path, in particular via a common print head supply line 205 and/or via a common print head discharge line 206.

The ink supply system 200 comprises an ink container 211 for ink 212. Ink 212 can be pumped from an ink reservoir (not shown) into the ink container 211 using a pump 210, for example a gear pump. Ink 212 can be conducted from the ink container 211, via a supply line 213, to an input-side distributor unit 221. A filter unit 214 for filtering the ink 212, in particular for cleaning the ink 212, can be arranged at the supply line 213. A supply valve 215 can also be arranged at the supply line 213, which supply valve 215 can be opened or closed in order to vary the volumetric flow of ink 212. The supply valve 215 can be designed such that the opening degree of the supply valve 215 can be varied continuously, for instance between 0% and 100%. The supply valve 215 can be a proportional valve.

The ink supply system 200 comprises an input-side pressure sensor 223 that is configured to detect measured pressure values with respect to the physical pressure of the ink 212 in and/or at the input-side distributor unit 221.

Starting from the input-side distributor unit 221, the ink 212 can be conducted to the individual print head groups 203. A print head supply line 205 can respectively lead from the input-side distributor unit 221 to the individual print head groups 203 in order to guide ink 212 from the input-side distributor unit 221 to the respective print head group 203. The individual print head supply lines 205 can respectively be opened or closed by a supply line valve 201.

A respective print head discharge line 206 can also lead from the individual print head groups 203 to an output-side distributor unit 223 in which the ink 212 from the individual print head groups 203 is collected. The individual print head discharge lines 206 can respectively be opened or closed by a discharge line valve 202.

The print head supply lines 205, the supply line valves 201, the print head discharge lines 206, and the discharge line valves 202 for two print head groups 203 are shown by way of example in FIG. 2. The ink supply system 200 for each print head group 203 of the print bar 102 typically has a respective print head supply line 205, supply line valve 201, print head discharge line 206, and discharge line valve 202.

The ink supply system 200 can comprise an output-side pressure sensor 224 that is configured to detect measured pressure values with respect to the physical pressure of the ink 212 in and/or at the output-side distributor unit 222.

Ink 212 can be pumped by a (negative pressure) pump 225, for example a gear pump, from the output-side distributor unit 22 into the ink container 211 via a discharge line 226.

As has already been presented, an air inclusion in a print head 103 or in a print head group 203 can occur during operation and/or during a servicing measure of the printing device 100. It has been observed that such an air inclusion leads to an increase in the resistance value, i.e. of the internal resistance, of the negatively affected print head 103, i.e. in general of the negatively affected print head group 203. The control device 101 of the printing device 100 can be configured to determine resistance information with respect to the resistance values, i.e. with respect to the internal resistances, of the individual print head groups 203 for the flow of ink 212 into, through, and/or out of the respective print head group 203. One or more print head groups 203 having an air inclusion can be identified based on the resistance information. In particular, it can be detected that one or more print head groups 203 exhibit an increased resistance value or internal resistance that, for example, is above a predefined resistance threshold. Based on this, it can be determined that these one or more print head groups 203 have an air inclusion.

If a print head group 203 with an air inclusion is identified, one or more regeneration measures can be implemented specifically for the identified print head group 203, which regeneration measures are intended to remedy the air inclusion in the identified print head group 203. The implementation of the one or more regeneration measures can be omitted in the one or more other print head groups 203 in which no air inclusion has been detected. A particularly resource-efficient regeneration of the print bar 102 can thus be effected.

Examples of regeneration measures are:
a purging of the identified print head group 203 with ink 212;
an increasing of the physical pressure of the ink 212 in the identified print head group 203; and/or
the producing of one or more specific ejection pulses of the nozzles 21, 22 of the identified print head group 203 in order to push the included air out of the chambers of the nozzles 21, 22 of the identified print head group 203.

The control device 101 can be configured to operate a print bar 102 in a screening mode that is intended to identify one or more print head groups 203 that have an air inclusion. The screening mode can, for example, be implemented following a servicing measure to service the print bar 102, in order to check that the service was performed correctly. Alternatively or additionally, the screening mode can be implemented between different printing phases and/or before the start of a printing phase of the printing device 100.

If air has been enclosed in a print head 103, the internal resistance of the one or more ink supply channels of the print head 103 increases. This is due to the fact that the air acts as a resistance in the cavities of the print head 103. The ink supply system 200 can be used to detect an air inclusion in a print head 103, generally in a print head group 203.

The print bar 102 to be examined has N different print head groups 203, with N≥1, in particular N≥2, and typically N≥4. The individual print head groups 203 can respectively have one or more print heads 103 that are arranged in parallel with one another with respect to the ink supply. For every single print head group 203, the ink supply system 200 comprises a respective supply line valve 201 and discharge line valve 202.

The valves 201, 202 of the N print head groups 203 can initially be closed for the screening mode. A defined, in particular constant, screening pressure of the ink 212 can be set in the input-side distributor unit 221 of the ink supply system 200. Measured pressure values of the input-side pressure sensor 223 can be detected for this purpose. The pump 210 can be operated depending on the measured pressure values of the input-side pressure sensor 223, in particular using a control loop, in order to set the defined screening pressure in the input-side distributor unit 221. The supply valve 215 can also be set to a defined, in particular constant, opening degree.

Following the setting of the screening pressure, the supply line valve 201 and the discharge line valve 202 can be selectively opened for precisely one print head group 203 in order to check this print head group 203. As a result of this, ink 212 flows from the input-side distributor unit 221, through the print head group 203—in particular through the one or more ink supply channels of the print head group 203—to the output-side distributor unit 222.

The (negative pressure) pump 225 at the output-side distributor unit 222 can be operated in order to adjust the physical pressure of the ink 212 to a designated target pressure in the output-side distributor unit 222. Measured pressure values of the output-side pressure sensor 224 can be detected for this purpose. The pump 225 can be operated depending on the measured pressure values of the output-side pressure sensor 224, in particular using a control loop, in order to adjust the designated target pressure in the output-side distributor unit 222.

Measured pressure values of the ink pressure in the input-side distributor unit 221 can be detected using the input-side pressure sensor 223. If the examined print head group 203 has no air inclusion, and thus exhibits a relatively low internal resistance, a relatively low ink pressure occurs in the input-side distributor unit 221. On the other hand, if the examined print head group 203 has an air inclusion, and as a result of this exhibits an increased internal resistance, the ink pressure in the input-side distributor unit 221 increases. This can be detected on the basis of the measured pressure values of the input-side pressure sensor 223. The pressure rise typically also leads to a reduction of the conveying velocity and/or of the rotational speed of the pump 210, which can be used as an alternative or supplementary indicator of the presence of an air inclusion.

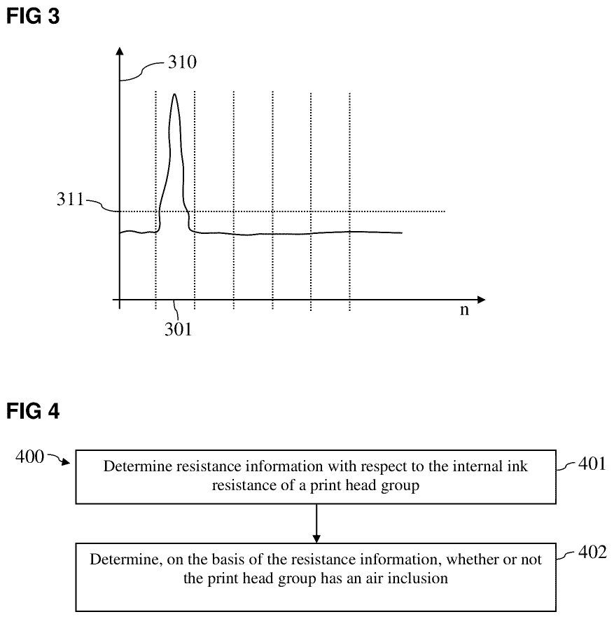

The N different print head groups 203 of the print bar 102 can accordingly be screened sequentially. As an example, FIG. 3 shows measured pressure values 310 of the input-side pressure sensor 223 for the N different print head groups 203 of the print bar 102, wherein the different print head groups 203 are identified by the index n, with n=1, . . . , N. The one or more measured pressure values 310 that are detected for a print head group 203 n can be compared with a pressure threshold 311. Whether or not the respective print head group 203 has an air inclusion can be determined based on the comparison. In the example depicted in FIG. 3, the print head group 203 identified with the index 301 has an air inclusion, in particular because the one or more measured pressure values 310 for this print head group 203 are greater than the pressure threshold 311.

If a print head group 203 with air inclusion is identified, the discharge line valve 202 of the identified print head group 203 can be closed in order to implement the one or more regeneration measures for the identified print head group 203.

The one or more regeneration measures can be implemented individually for the identified print head group 203, so that the one or more regeneration measures do not need to be implemented for all N print head groups 203 of the print bar 102.

FIG. 4 shows a workflow diagram of an example of a, possibly computer-implemented, method 400 for detecting a print head group 203 of a print bar 102 of an inkjet printing device 100 that has an air inclusion. The method 400 comprises determining 401 resistance information with respect to the internal resistance of one or more ink supply channels of a print head group 203 of the print bar 102. The one or more ink supply channels of the print head group 203 can be designed to conduct ink 212 from an ink input of the print head group 203 up to the ink output of the print head group 203. The internal resistance can relate to the resistance for ink 212 that flows through the one or more ink supply channels of the print head group 203. The internal resistance can comprise one or more measured pressure values 310, in particular one or more measured pressure values 310 with respect to the pressure of the ink 212 in the input-side distributor unit 221. The resistance information can be determined while the printing device 100, the print bar 102, and/or the ink supply system 200 are operated in a defined screening mode that is intended to screen one or more print head groups 203, in particular the N print head groups 203, of the print bar 102 respectively for the presence of an air inclusion.

The method 400 also comprises determining 402, based on the resistance information, whether or not the print head group 203 has an air inclusion. It can thereby be determined in particular whether the internal resistance of the one or more ink supply channels of the print head group 203 is greater than or less than a defined (resistance) threshold. If the internal resistance is greater than the defined threshold, it can be determined that an air inclusion is present. Otherwise, it can be determined that no air inclusion is present.

A (control) device 101 is thus described for the detection of a print head group 203 of a print bar 102 of an inkjet printing device 100 that has an air inclusion. The (control) device 101 can be part of the printing device 100. The print bar 102 can have N different print head groups 203, with N≥1 or N≥2, in particular N≥4. The individual print head groups 203 can respectively have one or more print heads 103 that can be arranged in parallel with one another with respect to the ink supply.

The individual print head groups 203 can respectively have one or more ink supply channels that are designed to conduct ink 212 through the respective print head group 203 in order to supply the nozzles 21, 22 of the respective print head group 203 with ink 212. The ink 212 can be provided at an input of the one or more ink supply channels, and can thereupon flow through the one or more ink supply channels. At least a portion of the ink 212 can be provided again at the output of the one or more ink supply channels.

The printing device 100 can have an ink supply system 200 that is designed to provide the ink 212 for the N print head groups 203 of the print bar 102. The ink supply system 200 of the printing device 100, in particular of the print bar 102, can have an input-side distributor unit 221 that is designed to provide ink 212 at the input of the one or more ink supply channels of the N different print head groups 203 of the print bar 102. Alternatively or additionally, the ink supply system 200 of the printing device 100, in particular of the print bar 102, can have an output-side distributor unit 222 that is designed to receive ink 212 from the output of the one or more ink supply channels of the N different print head groups 203 of the print bar 102.

For the N different print head groups 203, the print bar 102 can have a respective supply line valve 201 that is designed to open or close a print head supply line 205 from the input-side distributor unit 221 to the respective print head group 203. Furthermore, the print bar 102 for the N different print head groups 203 can have a respective discharge line valve 202 that is designed to open or close a print head discharge line 206 from the respective print head group 203 to the output-side distributor unit 222. The supply line valves 201 and/or the discharge line valves 202 of the N print head groups 203 thus enable a selective provisioning of ink 212 in the individual print head groups 203.

The ink supply system 200 can have an input-side pressure sensor 223 that is configured to detect one or more measured pressure values 310 with respect to the pressure of the ink 212 in the input-side distributor unit 221. Alternatively or additionally, the ink supply system 200 can comprise an output-side pressure sensor 224 that is configured to detect one or more measured pressure values with respect to the pressure of the ink 212 in the output-side distributor unit 221.

The ink supply system 100 can comprises a supply valve 215 that is designed to vary volumetric flow of ink 212 into the input-side distributor unit 221 by changing the opening degree of the supply valve 215. The supply valve 215 is preferably designed such that the opening degree can be adjusted, in particular can be essentially continuously adjusted, between 0% (i.e. completely closed) and 100% (i.e. completely open).

The ink supply system 100 can comprise an input-side pump 210 that is designed to convey ink 212 into the input-side distributor unit 221, in particular via an and/or from an ink container 211 and/or via the supply valve 215. Ink 212 for the N print head groups 203 can thus be reliably provided.

The ink supply system 100 can have an output-side pump 225 that is designed to pump ink 212 out of the output-side distributor unit 222, and in particular into the ink container 211. A through-flow of ink 212 through the N print head groups 203 can thus be reliably effected.

The (control) device 101 is configured to determine resistance information with respect to the internal resistance of the one or more ink supply channels of a print head group 203 of the print bar 102. The resistance information can be determined while the print bar 102 is operated in a defined screening mode.

To determine the resistance information for a defined print head group 203, the device 101 can be configured to selectively open the supply line valve 201 and the discharge line valve 202 for the defined print head group 203. The device 101 can also be configured to close the supply line valve 201 and the discharge line valve 202 for the N-1 other print head groups 203. To determine the resistance information for a defined print head group 203, it can thus be effected that ink 212 is conveyed exclusively through the one or more ink supply channels of the determined print head group 203, and not through the one or more ink supply channels of the N-1 other print head groups 203. The resistance information for the defined print head group 203 can thus be determined especially precisely.

The device 101 is also configured to determine, based on the resistance information, whether or not the print head group 203 has an air inclusion.

The device 101 can be configured to determine sequential and/or successive resistance information with respect to the internal resistance of the one or more ink supply channels of respectively precisely one print head group 203 of the N different print head groups 203 of the print bar 102. Successive resistance information for the individual print head groups 203 of the print bar 102 can thus be determined. For this purpose, the supply line valve 201 and/or the discharge line valve 202 of the respective print head group 203 can respectively be selectively opened while the supply line valve 201 and/or the discharge line valve 202 of the N-1 other print head groups 203 are closed.

Based on the resistance information of the individual print head groups 203, it can be determined whether or not the respective print head group 203 has an air inclusion. In particular, the one or more print head groups 203 that have an air inclusion can be identified from the N print head groups 203.

An air inclusion in a print head group 203 can be detected especially efficiently and reliably via the determination and consideration of resistance information.

The device 101 can also be configured to selectively execute one or more regeneration measures to regenerate the one or more identified print head groups 203. In particular, the one or more identified print head groups 203 can be selectively purged with ink 212 in order to remedy the air inclusion, whereas no regeneration measures are implemented for the one or more other print head groups 203. A particularly efficient regeneration of the print bar 102 can thus be produced.

To screen a defined print head group 203, the device 101 can be configured to produce a predefined pressure difference between the input and the output of the one or more ink supply channels of the defined print head group 203. This can be effected by the operation of the input-side pump 210 and/or of the output-side pump 225.

The device 101 can also be configured to determine volumetric flow information with respect to the volumetric flow of ink 212 from the input to the output of the one or more ink supply channels of the determined print head group 203. For example, this can be determined on the basis of the rotation speed of the input-side pump 210 and/or on the basis of the opening degree of the supply valve 215. The resistance information can then be determined on the basis of the volumetric flow information, in particular on the basis of the ratio between the predefined pressure difference and the volumetric flow.

To screen the defined print head group 203, the device 101 can alternatively or additionally be configured to effect a predefined volumetric flow of ink 212 from the input to the output of the one or more ink supply channels of the defined print head group 203. For example, this can be produced via operation of the input-side pump 210 and/or via adjustment of the opening degree of the supply valve 215.

The device can also be configured to determine pressure information with respect to the pressure difference between the input and the output of the one or more ink supply channels of the defined print head group 203. The pressure information can be determined on the basis of one or more measured pressure values of the input-side pressure sensor 223 and/or of the output-side pressure sensor 224. The resistance information can then be determined on the basis of the pressure information, in particular on the basis of the ratio between the pressure difference and the predefined volumetric flow.

To determine the resistance information, the device 101 can be configured to adjust the pressure of the ink 212 in the output-side distributor unit 222 to a defined target pressure.

The output-side pump 225 can thereby be operated, in particular depending on one or more measured pressure values of the pressure of the ink 212 in the output-side distributor unit 222, i.e. depending on one or more measured pressure values of the output-side pressure sensor 224, in order to adjust the pressure of the ink 212 in the output-side distributor unit 222 to the target pressure.

To determine the resistance information, the device 101 can also be configured to operate the supply valve 215 to determine the resistance information such that the volumetric pressure of ink 212 in the input-side distributor unit 221 is essentially constant. Alternatively or additionally, the opening degree of the supply valve 215 can be held essentially constant to determine the resistance information.

The device 101 can also be configured to detect at least one measured pressure value 310 of the pressure of the ink 212 in the input-side distributor unit 221, in particular using the input-side pressure sensor 223. The resistance information with respect to the internal resistance of the one or more ink supply channels of the respective print head group 203 can then be determined especially efficiently and precisely on the basis of the measured pressure value 310. The resistance information can in particular comprise the measured pressure value 310 or correspond to this.

For example, the device 101 can be configured to compare the measured pressure value 310 of the pressure of the ink 212 in the input-side distributor unit 221 with a pressure threshold 311. Based on the comparison, it can then be determined whether or not the print head group 203 has an air inclusion.

Alternatively or additionally, the device 101 can be configured to determine the resistance information on the basis of the rotation speed of the input-side pump 210 while ink 212 is conveyed from the input-side distributor unit 221, through the one or more ink supply channels of the respective print head group 203, to the output-side distributor unit 222.

Alternatively or additionally, the device 101 can be configured to adjust the pressure of the ink 212 in the input-side distributor unit 221 to a target pressure, and to effect a defined volumetric flow of ink 202 at the discharge line 226 from the output-side distributor unit 222, in particular by operation of the output-side pump 225. One or more measured pressure values of the pressure of the ink 212 can then be detected in or at the output-side distributor unit 222, and the resistance information can be determined on the basis of the one or more measured pressure values of the pressure of the ink 212 in or at the output-side distributor unit 222.

Furthermore, in this document an inkjet printing device 100 with an ink supply system 200 is described, wherein the printing device 100 comprises the control device 101 described in this document.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the terms “processing circuitry” and “control unit” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor.

The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 transport direction (of the recording medium)
21, 22 nozzle
31, 32 column (of the print image)
100 printing device
101 (control) device
102 print bar
103 print head
120 recording medium
140 print group
200 ink supply system
201 supply line valve
202 discharge line valve
203 print head group
205 print head supply line
206 print head discharge line
210 input-side pump
211 ink container
212 ink
213 supply line
214 filter unit
215 supply valve
221 input-side distributor unit
222 output-side distributor unit
223 input-side pressure sensor
224 output-side pressure sensor
225 output-side (negative pressure) pump
226 discharge line
301 index (print head group)
310 measured print head value
311 pressure threshold
400 method to detect a print head with air inclusion
401-402 method steps

1. An inkjet printing device comprising:
a print group comprising at least one print bar and the print bar comprising at least one print head group configured to print a print image onto the recording medium 120;
a control device configured to detect the print head group having an air inclusion, the control device comprising processing circuitry configured
to determine resistance information with respect to an internal resistance of one or more ink supply channels of the print head group of the print bar; and
to determine, based on the resistance information, whether the print head group has an air inclusion.

2. The inkjet printing device according to claim 1, wherein the processing circuitry of the control device is further configured
to produce a predefined pressure difference between an input and an output of the one or more ink supply channels of the print head group;
to determine volumetric flow information with respect to a volumetric flow of ink from the input to the output of the one or more ink supply channels of the print head group; and
to determine the resistance information based on the volumetric flow information; and/or
to produce a predefined volumetric flow of ink from the input to the output of the one or more ink supply channels of the print head group;
to determine pressure information with respect to a pressure difference between the input and the output of the one or more ink supply channels of the print head group; and
to determine the resistance information based on the pressure information.

3. The inkjet printing device according to claim 1, wherein
the print bar has N different print head groups, with N≥2; and
the processing circuitry of the control device is configured
to determine sequential resistance information with respect to the internal resistance of the one or more ink supply channels of respectively precisely one print head group of the N different print head groups of the print bar; and
to determine, based on the resistance information of the respective print head group, whether the respective print head group has an air inclusion.

4. The inkjet printing device according to claim 3, wherein
the print bar has a respective supply line valve for the N different print head groups, which supply line valve is configured to open or close a print head supply line from an input-side distributor unit to the respective print head group;
the print bar has a respective discharge line valve for the N different print head groups, which discharge line valve is designed to open or close a print head discharge line from the respective print head group to the output-side distributor unit; and
the processing circuitry of the control device, to determine the resistance information for a defined print head group, is configured to
selectively open the supply line valve and the discharge line valve for the defined print head group; and
close the supply line valve and the discharge line valve for the N-1 other print head groups.

5. The inkjet printing device according to claim 1, further comprising
an ink supply system having an input-side distributor unit that is configured to provide ink at an input of the one or more ink supply channels of the print head group of the print bar;
the ink supply system having an output-side distributor unit that is configured to receive ink from an output of the one or more ink supply channels of the print head group of the print bar; and, wherein
the processing circuitry of the inkjet printing device is configured
to set the pressure of the ink in the output-side distributor unit to a target pressure;
to detect a measured pressure value of the pressure of the ink in the input-side distributor unit; and
to determine resistance information with respect to the internal resistance of the one or more ink supply channels of the print head group on the basis of the measured pressure value.

6. The inkjet printing device according to claim 5, wherein the processing circuitry of the inkjet printing device is configured
to compare the measured pressure value of the pressure of the ink in the input-side distributor unit with a pressure threshold; and
to determine, based on the comparison, whether the print head group has an air inclusion.

7. The inkjet printing device according to claim 5, wherein
the ink supply system has a pump that is designed to pump ink out of the output-side distributor unit, and into an ink container; and
the processing circuitry of the control device is configured to operate the pump in order to set the pressure of the ink in the output-side distributor unit to the target pressure.

8. The inkjet printing device according to claim 7, wherein
the processing circuitry of the control device is configured to operate the pump depending on one or more measured pressure values of the pressure of the ink in the output-side distributor unit.

9. The inkjet printing device according to claim 5, wherein
the ink supply system comprises a supply valve that is configured to vary a volumetric flow of ink into the input-side distributor unit by changing an opening degree of the supply valve; and
the processing circuitry of the control device is configured
to operate the supply valve to determine the resistance information such that the volumetric flow of ink into the input-side distributor unit is essentially constant; and
to keep the opening degree of the supply valve essentially constant for the determination of the resistance information.

10. The inkjet printing device according to claim 5, wherein
the ink supply system comprises a pump that is configured to convey ink into the input-side distributor unit, via an ink container and/or via a supply valve; and
the processing circuitry of the control device is configured to determine the resistance information based on a rotation speed of the pump while ink is conveyed from the input-side distributor unit, via the one or more ink supply channels of the print head group, to the output-side distributor unit.

11. A method for detecting a print head group of a print bar of an inkjet printing device with an air inclusion, the method comprising
determining resistance information with respect to an internal resistance of one or more ink supply channels of the print head group of the print bar ; and
determining, based on the resistance information, whether the print head group has an air inclusion.

12. The method according to claim 11, further comprising
producing a predefined pressure difference between an input and an output of the one or more ink supply channels of the print head group;
determining volumetric flow information with respect to a volumetric flow of ink from the input to the output of the one or more ink supply channels of the print head group; and
determining the resistance information based on the volumetric flow information; and/or
producing a predefined volumetric flow of ink from the input to the output of the one or more ink supply channels of the print head group;
determining pressure information with respect to a pressure difference between the input and the output of the one or more ink supply channels of the print head group; and
determining the resistance information based on the pressure information.

13. The method according to claim 11, wherein
the print bar has N different print head groups, with N≥2; and
the method further comprising
determining sequential resistance information with respect to the internal resistance of the one or more ink supply channels of respectively precisely one print head group of the N different print head groups of the print bar; and
determining, based on the resistance information of the respective print head group, whether the respective print head group has an air inclusion.

14. The method according to claim 13, wherein
the print bar has a respective supply line valve for the N different print head groups, which supply line valve is configured to open or close a print head supply line from an input-side distributor unit to the respective print head group;
the print bar has a respective discharge line valve for the N different print head groups, which discharge line valve is designed to open or close a print head discharge line from the respective print head group to the output-side distributor unit; and
the method further comprises:
selectively opening the supply line valve and the discharge line valve for the defined print head group; and
closing the supply line valve and the discharge line valve for the N-1 other print head groups.

15. The method according to claim 11, wherein the inkjet printing device further comprises
an ink supply system having an input-side distributor unit that is configured to provide ink at an input of the one or more ink supply channels of the print head group of the print bar;
the ink supply system having an output-side distributor unit that is configured to receive ink from an output of the one or more ink supply channels of the print head group of the print bar; and,
the method further comprises
setting the pressure of the ink in the output-side distributor unit to a target pressure;
detecting a measured pressure value of the pressure of the ink in the input-side distributor unit; and
determining resistance information with respect to the internal resistance of the one or more ink supply channels of the print head group on the basis of the measured pressure value.

16. The method according to claim 15, further comprising
comparing the measured pressure value of the pressure of the ink in the input-side distributor unit with a pressure threshold; and
determining, based on the comparison, whether the print head group has an air inclusion.

17. The method according to claim 15, wherein
the ink supply system has a pump that is designed to pump ink out of the output-side distributor unit, and into an ink container; and
the method further comprising operating the pump in order to set the pressure of the ink in the output-side distributor unit to the target pressure.

18. The method according to claim 17, wherein
operating the pump depends on one or more measured pressure values of the pressure of the ink in the output-side distributor unit.

19. The method according to claim 15, wherein
the ink supply system comprises a supply valve that is configured to vary a volumetric flow of ink into the input-side distributor unit by changing an opening degree of the supply valve; and
the method further comprises
operating the supply valve to determine the resistance information such that the volumetric flow of ink into the input-side distributor unit is essentially constant; and
keeping the opening degree of the supply valve essentially constant for the determination of the resistance information.

20. The method according to claim 15, wherein
the ink supply system comprises a pump that is configured to convey ink into the input-side distributor unit via an ink container and/or via a supply valve; and
the method further comprises determining the resistance information based on a rotation speed of the pump while ink is conveyed from the input-side distributor unit, via the one or more ink supply channels of the print head group, to the output-side distributor unit.
